(19) United States
(12) Patent Application Publication
(10) Pub. No.: US 2019/0199694 A1
(43) Pub. Date: Jun. 27, 2019

(54) INDIVIDUAL ENCRYPTION OF CONTROL COMMANDS

(71) Applicant: BUILD38 GMBH, München (DE)

(72) Inventors: Daniel ALBERT, München (DE); Helmut SCHUSTER, Irsee (DE)

(21) Appl. No.: 16/322,334

(22) PCT Filed: Jul. 26, 2017
(86) PCT No.: PCT/EP2017/000904

§ 371 Date: Jan. 31, 2019

(30) Foreign Application Priority Data
Aug. 3, 2016 (DE) 10 2016 009 439.7

(51) Int. Cl. H04L 29/06; H04L 9/32; H04W 12/00

(52) U.S. Cl. CPC H04L 63/0428; H04L 9/3247; H04L 2209/80; H04L 2209/16; H04L 2209/08; H04W 12/0013

(57) ABSTRACT

The present invention is directed to a method for efficiently and individually encrypting control commands, which makes it possible to encrypt supplied applications and to transmit them to an end device not only in an efficient but also in a particularly secure way.

The present invention is directed to a method for efficiently and individually encrypting control commands, which makes it possible to encrypt supplied applications and to transmit them to an end device not only in an efficient but also in a particularly secure way. The invention is also directed to an accordingly arranged encryption apparatus and to a computer program product with control commands which implement the proposed method or operate the proposed encryption apparatus.

US 2007/0257360 A1 describes a method for providing protection against illegal copies of programs from a mobile device. Here, an application is encrypted with a key that is dependent on a device identifier.

WO 2009/010338 shows a computer-aided obfuscation of a software program, wherein a source code of the software program is provided with one or several annotations, each annotation being associated with a particular code portion of the source code and comprising information as to whether or not the respective code portion is to be obfuscated.

WO 2010/037525 teaches a method for configuring electronic devices, whereby encryption is effected based on a first secret stored in the electronic device and used by the algorithm.

DE 10 2012 201505 B4 shows an authentication system in which an individualized application is loaded onto a mobile phone device.

It is known to supply applications in the form of control commands via a central interface, for example a so-called app store, using corresponding encryption algorithms including signatures. In particular cryptographic methods are known for this, which for example include asymmetric methods in which a secret and a public key are used. Furthermore, various pseudo-encryption methods are known, which only make it more difficult to imitate source code, but do not prevent this. Here it is known, for example, to obfuscate a source code. This means that the source code is changed, for example, with regard to the order and the naming of parameters and methods, without the supplied functionality changing. For example, so-called speaking variable names can be changed such that they merely consist of any alphanumeric characters and thus do not make any semantic sense to a human observer.

Today's standard app stores work according to the principle that every end customer receives an identical copy of the same signed app. The process from the developer to the installation of the app on a device (smartphone, tablet, notebook, PC) of the end customer is as follows:

1. The developer compiles the program and creates an .apk-file for the Android Play Store or a bundle for Apple's Appstore. An .apk-file in the end is a .zip-file that must contain certain files so as to be complete, e.g. executable code, resources such as images or icons, screen layouts, and a so-called “manifest” file that serves as a description of the application.

For simplicity's sake, reference will be made only to .apk-files, although the method also refers to app bundles for iOS.

2. The program file is signed with the developer key.
3. The developer submits the complete and self-contained .apk-file to the app store.
4. The app store checks the .apk-file and the app contained therein for malicious code, viruses and “inappropriate content.”
5. If the .apk-file has passed the check by the app store, the app store will make it available for download.
6. If an end customer now selects this app (this .apk-file) for purchase or download, he will receive an identical copy of the .apk-file transferred in step 3.
7. The installer on the end customer's end device checks the signature of the file and thus the completeness of the file.
8. If the signature has been successfully checked and the end customer agrees to the rights requested by the app, the installer installs the app/the .apk on the end device.

According to the known methods it is particularly disadvantageous, when a plurality of control commands has to be encrypted and there thus exists an increased technical effort. According to known methods, no distinction is made whether it is necessary to encrypt all control commands at all, rather an entire application is encrypted and sent. Especially secure cryptographic methods typically are computationally intensive, which means that corresponding hardware capacities must be available. Also, the applications typically have to be supplied by means of a secured region, even when these partially contain control commands that are not security-critical.

Furthermore, against the prior art it is particularly disadvantageous that an encryption is often carried out with passwords which are known on both sides, i.e. on the transmitter side and receiver side. Although there are a few methods which use different keys, these are also configured such that if an attacker comes into possession of a key, he can gain unauthorized access to the data.

It is therefore an object of the present invention to supply a method which allows a secure encryption to be carried out with little technical effort. The aim is also to make it possible for end devices which have low hardware capacities to participate in a secure encryption or decryption. Furthermore, control commands are to be supplied in a particularly secure manner by means of a network. It is further an object of the present invention to supply an accordingly arranged apparatus or to supply a computer program product which has control commands which implement the proposed method or operate the proposed apparatus.

The object is achieved with the features of claim 1. Further advantageous configurations are stated in the subclaims.

Accordingly, a method for efficiently and individually encrypting control commands for single end devices is proposed. Proposed are the steps of supplying a set of control commands by means of a communication network and identifying a subset of the control commands which provide security-critical functionality. Further, an encryption of only the subset of control commands is effected, whereby encrypting is effected in dependence on an end device identifier.

According to the invention it is particularly advantageous that the method can be implemented very efficiently, since not all control commands are encrypted, as it is known, but only those control commands are identified which actually have to be encrypted as these supply security-critical functionality. This saves substantial calculation steps for encrypting control commands, and it is possible, for example, to operate the proposed method on a mobile end device. It is also particularly advantageous that only a subset is encrypted, since computing capacities on servers are also limited. Although servers have considerable hardware resources, they also supply a large number of applications and control commands. Thus, the advantage of the invention scales such that a large number of applications can be supplied on a server and the server accordingly saves control commands per application which do not have to be encrypted. A server can thus supply several applications with the same hardware load, since these applications have to be encrypted only partially.

Further, encrypting is effected individually such that for encrypting an end device identifier is used. It is thus particularly advantageous that no generic keys are used and thus the same encrypted application is supplied to each user, rather each application having various control commands is encrypted specifically for one user. According to the invention, this is possible because not all control commands are encrypted, but only the security-critical ones. Since the individual encryption represents a considerable technical effort, the combination of a partial encryption and an individual encryption is particularly advantageous, because a secure encryption can be supplied which does not require more hardware capacities than conventional methods.

Thus, according to the invention, the additional technical effort of an individual encryption is cancelled by the fact that only subsets of control commands have to be encrypted. Thus, these two technical effects cooperate synergistically such that a particularly secure encrypted code can be supplied without upgrading existing environments.

The set of control commands is supplied by means of a telecommunication network such that, for example, a developer's computer transmits the control commands to a central server which can then take over the further method steps. This is advantageous in particular because the proposed method can be seamlessly integrated in existing environments. There are known platforms which distribute applications or control commands to users upon their request. Thus, according to the invention it is possible to further transmit control commands by means of a data connection to a server and this then analyzes the supplied control commands in a self-acting fashion such that it can be ascertained which control commands must be encrypted and which not.

Identifying a subset of control commands supplying security-critical functionality can be performed automatically but also manually. In the case of a manual determination, information which describes which control commands are security-critical is inserted manually into the source code. This can be done, for example, by annotating the source code. Here, on the server side a parser can then search the source code and ascertain which control commands are marked as security-critical. The same applies to parameters or variables, which may also have to be encrypted. In this connection, some annotation languages are already known which can be reused according to the invention. Thus it is a task of the developer to prepare his source code or the control commands such that information can be read out which supplies an indication of a security-critical functionality.

In the case of an automatic identification of the security-critical control commands, for example sequence diagrams can be analyzed such that it is ascertained with which communication partners a control command communicates. For example, within the control commands, an interface can be identified which is provided for communication with a security-critical component. Thus, the corresponding control commands can be marked as security-critical. Further, variable names or variable types indicating an encryption can be identified accordingly. If, for example, a secure protocol or secure data transmission takes place in the control commands, this is already an indication of a security-critical functionality. Also, corresponding variable names or method names can give an indication of a security-critical function. Also, a memory structure can be analyzed such that certain packets or classes of control commands are generally considered security-critical. For example, it is possible to store these packets or classes in a specific folder or to use predefined packet names or class names. In this way, the server always knows which subset of control commands is to be encrypted and which control commands do not have to be encrypted.

Further, it is possible to individually encrypt the identified subset of control commands having security-critical functions by means of a device identifier, and to not encrypt the remaining second subset or to encrypt it with conventional methods. There is thus a first subset of control commands which are security critical and thus have to be encrypted with the particularly secure proposed methods. The second subset of control commands which do not supply security-critical functionality is thus not encrypted or is encrypted merely with conventional methods. It is thus in turn possible to resort to existing environments and to also use existing encryption algorithms. Since individual encryption, as proposed here, can lead to additional technical effort, it is still very efficient to encrypt only the necessary control commands individually and to encrypt the other control commands, for example, asymmetrically or according to conventional methods.

Any supplied service or data which are to be protected against unauthorized access is considered a security-critical functionality. For example, sensitive data can give an indication of personal information about users. Thus, security-critical functions are those functions which read or write such data. This is to prevent personal data deserving special protection from being read out. Furthermore, the control commands can manage user accounts or even bank information. Thus, these control commands require an accordingly secure protection in order to ensure that no data manipulation occurs. Another class of security-critical functionalities is supplied in that certain system parameters or a system functionality is not allowed to be read out or changed. This makes it possible to access an underlying operating system of the end device with the control commands. However, this should be avoided such that corresponding operations are specifically encrypted and can only be decrypted by a certain user. For example, it is possible to execute the control commands such that only one machine uses the services thereof without it being possible to decrypt and, where applicable, manipulate these data. This prevents that control commands that access a memory region are rewritten such that they also gain access to unauthorized memory regions. The person skilled in the art here knows further examples of security-critical functionalities.

Encryption in dependence on an end device identifier can be carried out such that at least one end device identifier is used for this. Thus, an individual encryption of at least one end device is effected. An end device identifier can be, for example, an information item that is written into an end device in hard-coded fashion. For example, it is possible to read out a serial number which is assigned uniquely to each device. Thus, when requesting control commands the corresponding end device can also send its device identifier, or the supplying server or the supplying instance can request this end device identifier. Thus, the server is provided with a request which specifies which control commands are to be supplied, and this end device identifier is also present. Thus, the server can decide which subset of control commands is now to be encrypted according to the invention and can further use the end device identifier of the requesting user for this encryption.

This results in an individual encryption or a supplying of individually encrypted control commands. This is individual because the same control commands can be supplied to each requesting user, but these are individually encrypted according to the present end device identifier.

It is therefore an advantage of the present invention that an attacker who wants to gain access to security-critical control commands cannot even design an attack algorithm that would be equally valid for all transferred control commands. Rather, an attacker would have to individually attack or individually decrypt all the transmitting control commands of each end device. It is thus not sufficient for the attacker to ascertain a password by means of a so-called brute-force attack, which password is then valid for all encryptions of the control commands. Rather, the computing effort on the part of the attacker increases considerably, because only one set of control commands can be decrypted by means of a password. Thus, the resulting damage is also drastically minimized, since not all applications of a server are affected. This makes it much less interesting for an attacker to decode the encryption used. Most likely, an attacker would refrain from decoding intercepted data because he would rather look for other targets which use conventional data encryption.

According to one aspect of the present invention, encryption is effected in dependence on the end device identifier of an end device which requests the set of control commands. This has the advantage that the subset of control commands can be individually encrypted for every single user. Therefore, it is possible for a user to request control commands by means of his end device and to thereby transfer his end device identifier or supply the end device identifier for being read out.

According to another aspect of the present invention, the encryption is effected in dependence on the end device identifier of an end device which supplies the set of control commands to another end device. This has the advantage that, alternatively or additionally to the end device identifier of the requesting end device, also the end device identifier of the supplying server can be encoded. Thus, an encryption of the subset of control commands is effected using a server identifier, which represents an additional security feature. Thus, according to the invention, also an individual encryption of a subset of control commands is effected, this, however, being based on the server which supplies the control commands. In this way there can also safeguarded that the control commands are supplied by the correct server or by the correct server application. This prevents the control commands from being downloaded by an untrustworthy entity.

According to another aspect of the present invention, encryption is performed by means of obfuscation. This has the advantage that, alternatively or additionally to known encryption methods, a method is applied which does not impair the functionality of the control commands, but prevents or considerably complicates the human readability of the control commands.

According to another aspect of the present invention, the encoding is effected in dependence on a random number. This has the advantage that, for example, the obfuscation can be carried out using a so-called “seed” which can be generated by means of a random number and discarded in the further process, as this is no longer required. This again guarantees a further security feature according to the invention.

According to another aspect of the present invention, at least the encrypted subset of control commands is provided with a signature. This has the advantage that especially the security-critical functionality is safeguarded by the signature. Here, a digital signing of the encrypted subset is effected, for example, by the server. Thus it is also ensured that the transmitted control commands actually arrive properly on the receiver side. Thus, the signature can also be checked on the receiver side and in particular the security-critical control commands can be verified.

According to another aspect of the present invention, the set of control commands comprising encrypted and unencrypted control commands is supplied to an end device by means of a telecommunication network. This has the advantage that the user's end device is supplied with the control commands by means of a data line. In particular, it is advantageous to hold further components available in the telecommunication network, which are necessary for the implementation of the proposed method. It is thus an advantage of the invention that the encryption can be performed on a central server instance and the control commands can also be supplied across several components, for example by means of the telecommunication network, without any security impairment taking place.

According to another aspect of the present invention, the identification is effected in dependence on a textual marking. This has the advantage that already existing annotated control commands can be reused, and in particular that a simple method is taught which, already upon implementation or programming, allows a developer to insert text markers which indicate a security-critical functionality. In particular there are already known markup languages which can be interpreted by corresponding parsers. Thus, no great technical effort arises because existing components can be used.

According to another aspect of the present invention, the identification is effected in dependence on a memory structure of the control commands. This has the advantage that already the developer can establish, by means of a folder structure or by setting up single packets or classes, which control commands provide security-critical functionalities, and thus have to be encrypted according to the proposed method. Here, it is particularly advantageous that a memory structure can be read out particularly efficiently and, above all, in a self-acting fashion. Thus, no human intervention is necessary, rather the proposed method can be carried out automatically.

According to another aspect of this invention, the set of control commands is present as source code. This has the advantage that the control commands are not compiled, rather these are present as pure text, and thus the technical effort of encrypting or obfuscating is very low. Generally, according to the invention it is possible to encrypt the control commands also in their binary representation or generally in a compiled form, but this is technically more complex and requires more efficient hardware resources.

According to another aspect of the present invention, the supplied control commands have parameters which are provided with values only upon request of an end device. This has the advantage that the control commands have both static and dynamic parts, i.e. control commands which are at least partially not changed and control commands that are changed in part before a supplying or at runtime. These can be control commands which are to be provided with time stamps or the like, and therefore are dynamic because these will be adapted. Thus, the proposed method can also be applied to dynamically generated control commands, which are encrypted or signed accordingly.

According to another aspect of the present invention, further control commands are provided, which supply the set of control commands comprising encrypted and unencrypted control commands to an end device. This has the advantage that existing environments, for example an app store, can be reused and therefore the further control commands do not have to be newly implemented. Thus, the proposed method can be embedded in existing environments without the need for adaptation. Thus, the control commands supplied are to be distributed merely by means of the further control commands. Furthermore, these further control commands can also perform the identifying or encrypting.

According to another aspect of the present invention, the further control commands add a signature to the set of control commands. This has the advantage that the environment also signs the set of control commands and does not merely supply these. The signing can refer, in particular, to the dynamic part of the control commands which are thus safeguarded accordingly.

The object is also achieved by an encryption apparatus for efficiently and individually encrypting control commands for single end devices, having an interface unit arranged for supplying a set of control commands by means of a telecommunication network and an analyzing unit arranged for identifying a subset of the control commands supplying a security-critical functionality. Furthermore, an encryption unit is provided which is arranged for encrypting merely the subset of control commands, the encryption being effected in dependence on an end device identifier.

Furthermore, the object is achieved by a computer program product with control commands that implement the method or operate the proposed encryption apparatus.

According to the invention, it is particularly advantageous that the method proposes method steps which can be implemented by means of structural features of the encryption apparatus. Furthermore, the encryption apparatus provides structural features which can also be implemented as method steps.

The present invention will now be explained by means of exemplary figures. There are shown:

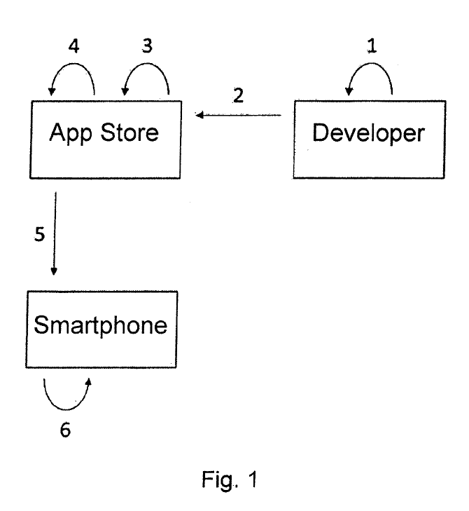

FIG. 1: a block diagram of an encryption arrangement according to one aspect of the present invention; and

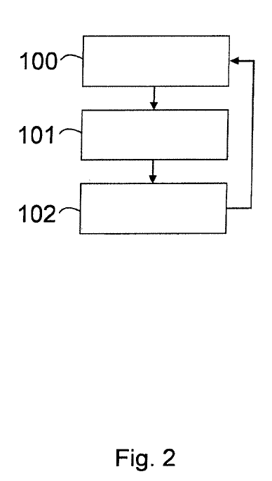

FIG. 2: a method for individually encrypting control commands according to one aspect of the present invention.

FIG. 1 shows an arrangement in which a developer creates control commands and distributes these by means of a central server unit, for example an app store, to users who retrieve these control commands by means of their smartphones. If security-critical applications are distributed via such central distributors, an attacker can analyze the application and transmit the results of the analysis to all the users of the application. The attacker only needs to analyze the application once in order to attack all the users of the application.

For this, according to the invention, in the application, i.e. in the control commands, there can be stored information designating security-critical data by the developer. Only static parts of the applications are signed with a developer key. This is effected in a method step 1 as shown in FIG. 1.

Thereafter, in a further method step 2, a transmission of the application from the developer to the app store is effected. Thereupon, in method step 3, it is effected that upon a selection of the application in the app store it is checked by the customer which data are security-critical. The security-critical data are obfuscated individually for each customer and each device.

In a subsequent step 4, the dynamic parts of the application are signed with a key of the app store, and the signature is added to the developer's signature of point 1.

In method step 5, the application is then transmitted from the app store to the customer. In the following method step 6, the installer on the customer's smartphone checks the signature of the developer over static parts and the signature of the app store over the dynamic parts.

Thus, an attack on security-critical applications without secure element is made more difficult. Furthermore, the developer does not have to perform the obfuscation himself. The changes to the customer device therefore only affect the installer and are therefore minimal.

Obfuscation is understood to be the carrying out of a method by which a program or source code is put into a form that is difficult for humans to read or understand in order to make attacks or reverse engineering more difficult. However, the actual program still runs equivalent to the original program.

The term manifest refers to a metafile which includes (optional) descriptive properties of a program. This is present in various platforms, such as Windows or Java.

Security-critical parts in a program are all parts that contain keys or sensitive operations. This means that the calculation of the payment token based on the credit card data contains two security-critical aspects: credit card data and algorithmic calculations of the payment token.

Recognizing which parts are critical and which not is very difficult, as this is part of the application file or overall system.

Furthermore, obfuscating native code increases security compared to Java bitcode. Native code runs on the processor for a special architecture. This code is highly optimized, parallelized and machine-oriented, i.e. difficult to understand for a person. Java code is a so-called intermediate code for a virtual architecture. A virtual machine transforms the intermediate code into the actual machine language of the architecture. Since Java interprets the intermediate code, it is not possible to execute arbitrary obfuscations, otherwise the virtual machine cannot translate the code any more.

Static or dynamic parts of control commands can be defined, for example, as follows. Each application is static, i.e. the developer compiles the program and this is placed in the app store and downloaded by the end user statically, i.e. unchanged. Each user gets the same program. Dynamic means, however, that the app store may generate certain parts in the program, e.g. random numbers, RSA key pair, time/date, . . . , i.e. each user gets a different program.

If the control commands are static, the developer signs the application with his key and places it in the app store. This ensures that nothing was changed when the application was transferred. If parts of the application are dynamic and are only filled or generated by the app store when the end user downloads them, a signature cannot be calculated via the dynamic parts; this is effected by the app store instead. This signature of the app store is then appended to the entire application.

A static signature here is a signature over all parts of the application, code, images, strings, or the like, which are not changed after the compilation at the developer. A dynamic signature is a signature over all parts that have been created or generated in the app store user-specifically.

There are also cases in which the app store signs. This is up to the app store provider, whether or not this is provided. when applications contain dynamic segments, it may be necessary in order to trust this code or data regions.

According to the invention, it is particularly advantageous that the method steps cited in the prior art are extended according to the invention. At the outset, eight method steps have been described, via which standard app stores work. There is described the sequence from the developer up to the installation of the app on a device, i.e. smartphone, tablet, notebook, PC, of the end customer. These method steps are extended according to one aspect of the present invention, as follows.

Extension of step 1:

In the “manifest” file, the developer stores additional information that defines which of the executable files or code segments within the .apk-file are particularly security-critical. Preferably, the developer outsources the critical functions in separate executable files, so that the app and its runtime are not unnecessarily bloated by the obfuscation.

Preferably, the security-critical executable files are not present in Java bytecode, but in native code. This drastically increases the security of the obfuscation.

Extension of step 2:

Before the signature is generated, the manifest file of the .apk is checked to see whether an executable file in the .apk is marked as security-critical.

If this is the case, a signature is not calculated over the entire .apk, but merely over the still static parts. For apps without security-critical parts, the signature over the entire .apk is added, as usual.

Extension of step 6:

If the .apk does not have a complete signature, the manifest file of the .apk is checked to see which executable files are marked as security critical. These files are obfuscated individually per download, i.e. the .apk made available is obfuscated individually not only for each end customer, but also for every single device of the end customer. This additionally increases security. The necessary “seed” for carrying out the obfuscation is generated by means of a random number and discarded after the obfuscation because it is no longer needed.

Via the dynamized values within the APK, a signature is calculated with the key of the app store and this is added to the signature of the app developer. Subsequently, the .apk is transmitted to the end device of the end customer as usual.

Extension of step 7:

The installer on the end device examines the static signature of the developer as well as the optional signature of the app store on the dynamic content.

FIG. 2 shows a method for efficiently and individually encrypting control commands for single end devices. Provided are the steps of supplying 100 a set of control commands by means of a telecommunication network. Furthermore, there is effected an identifying 101 of a subset of the control commands which supply a security-critical functionality. In addition, there is effected an encrypting 102 of merely the subset of control commands, encrypting being effected in dependence on an end device identifier.

Not shown is a data carrier having a computer program product with control commands which implement the proposed method or operate the proposed apparatus.

1.-15. (canceled)

16. A method for efficiently and individually encrypting control commands for single end devices, comprising the steps of:
supplying a set of control commands by means of a telecommunication network;
identifying a subset of the control commands which supply a security-critical functionality; and
encrypting merely the subset of control commands, wherein the encrypting is effected in dependence on an end device identifier.

17. The method according to claim 16, wherein encrypting is effected in dependence on the end device identifier of an end device which requests the set of control commands.

18. The method according to claim 16, wherein encrypting is effected in dependence on the end device identifier of an end device which supplies the set of control commands to a further end device.

19. The method according to claim 16, wherein encrypting is effected by means of obfuscating.

20. The method according to claim 16, wherein encrypting is effected in dependence on a random number.

21. The method according to claim 16, wherein at least the encrypted subset of control commands is provided with a signature.

22. The method according to claim 16, wherein the set of control commands comprising encrypted and unencrypted control commands is supplied to an end device by means of a telecommunication network.

23. The method according to claim 16, wherein identifying is effected in dependence on a textual marking.

24. The method according to claim 16, wherein identifying is effected in dependence on a memory structure of the control commands.

25. The method according to claim 16, wherein the set of control commands is present as source code.

26. The method according to claim 16, wherein the supplied control commands have parameters which are provided with values only upon request of an end device.

27. The method according to claim 16, wherein further control commands are provided which supply the set of control commands comprising encrypted and unencrypted control commands to an end device.

28. The method according to claim 27, wherein the further control commands add a signature to the set of control commands.

29. An encryption apparatus for efficiently and individually encrypting control commands for single end devices, comprising:
an interface unit arranged to supply a set of control commands by means of a telecommunication network;
an analyzing unit arranged to identify a subset of the control commands supplying a security-critical functionality; and
an encryption unit arranged to encrypt merely the subset of control commands, wherein encrypting is effected in dependence on an end device identifier.

30. A computer program product having control commands which implement the method according to claim 16.
